(19) United States
(12) Patent Application Publication
(10) Pub. No.: US 2022/0098505 A1
(43) Pub. Date: Mar. 31, 2022

(54) USE OF A PARAFFINIC HYDROCARBON-BASED FUEL COMPOSITION FOR CLEANING THE INTERNAL PARTS OF DIESEL ENGINES

(71) Applicant: TotalEnergies Marketing Services, Puteaux (FR)

(72) Inventors: Géraldine DELORME, Brignais (FR); Roland DAUPHIN, Bruxelles (BE)

(73) Assignee: TotalEnergies Marketing Services, Puteaux (FR)

(21) Appl. No.: 17/427,078

(22) PCT Filed: Jan. 24, 2020
(86) PCT No.: PCT/EP2020/051740

§ 371 Date: Jul. 29, 2021

(30) Foreign Application Priority Data
Jan. 31, 2019 (FR) 1900938

(51) Int. Cl. C10L 10/06; C10L 1/2383; C10L 1/222; C10L 1/232; C10L 1/228; C10L 1/08

(52) U.S. Cl. CPC C10L 10/06; C10L 1/2383; C10L 1/2225; C10L 1/232; C10L 2250/04; C10L 1/08; C10L 2200/0446; C10L 2200/0484; C10L 2230/081; C10L 1/2283

(57) ABSTRACT

The present invention relates to the use of a fuel composition comprising at least 85% by weight of one or more hydrocarbon fractions consisting of one or more hydrotreated vegetable oils, said fraction(s) having a distillation range between 100 and 400° C. and having a paraffin content greater than or equal to 90% by weight, for reducing the deposits present in the internal parts of a compression ignition engine (or diesel engine). The present invention also relates to a method for cleaning the deposits present in the internal parts of a compression ignition engine using such a composition.

The present invention relates to the use of a fuel composition based on one or more paraffin-rich fractions consisting of hydrotreated vegetable oils, for reducing the deposits present in the internal parts of a compression ignition engine (or diesel engine).

The present invention also relates to a method for cleaning the deposits present in the internal parts of a compression ignition engine, using such a composition.

### DESCRIPTION OF THE PRIOR ART

Liquid fuels of internal combustion engines contain components that may degrade during the functioning of the engine. The issue of deposits in the internal parts of combustion engines is well known to motorists. It has been shown that the formation of these deposits has consequences on the performances of the engine and particularly has a negative impact on consumption and pollutant emissions.

To address this issue, many so-called “detergent” additives have been developed, that is to say particular chemical compounds that, added in very low content (in the order of 1 to 1000 ppm by weight), make it possible to reduce the deposits in the internal parts of engines. Detergent additives have been proposed to keep the engine clean by limiting the deposits (keep-clean effect) or by reducing the deposits already present in the internal parts of the combustion engine (clean-up effect).

Nevertheless, engine technology is constantly evolving and the requirements regarding fuels must evolve in order to keep up with these technological advances. In particular, the novel diesel direct injection systems expose the injectors to more severe pressure and temperature conditions, which promotes the formation of deposits. Furthermore, these novel injection systems have more complex geometries to optimise the spraying, particularly more numerous holes having smaller diameters but that, on the other hand, induce greater sensitivity to deposits. The presence of deposits may impair the performances of the combustion, particularly increase pollutant emissions and particle emissions. Other consequences of the excessive presence of deposits are in particular the increase in fuel consumption and driveability problems.

In addition, the solutions currently available essentially target the prevention of deposits (keep-clean effect), and there are relatively few solutions that make it possible to clean the internal parts of engines that are already dirty particularly due to the use of fuels the detergent properties of which are insufficient for example due to the too low content or mediocre performances of the detergent agents present in these fuels.

However, not only the prevention but also the reduction of deposits in engines are essential for an optimum functioning of current diesel engines.

In addition, it would be desirable to be able to have alternative solutions to the use of detergent additives, which often proves to be relatively expensive and increases the prices of fuels for consumers.

Moreover, most of the detergent additives currently used tend to degrade the demulsifying of liquid fuels for internal combustion engines, in particular diesel fuels. In a manner known per se, due to the processes implemented for the extraction of crude oil but also due to the condensation of water within cold fuel during its transportation and its storage, the fuels comprise a variable amount of water that may range from a few parts per million to a few percent by mass in relation to the total mass of the fuel. The presence of this residual water generally leads to the formation of stable emulsions that, being in suspension within the fuel, are the cause of numerous problems occurring during the transportation and/or during the combustion of these fuels. For example, these emulsions may cause the obstruction of the engine filters or even accelerate the corrosion of the engine.

In addition, the use in substantial amount of detergent additives is likely to degrade the lubricity features of the fuel composition.

Therefore, there is a need to propose novel solutions for effectively cleaning the deposits present in dirty diesel engines, which make it possible to reduce the amount of detergent additives used, or even to entirely dispense with such additives.

These solutions must make it possible to re-establish optimum functioning of compression ignition engines regardless of the engine technology, including for novel engine technologies such as diesel direct injection.

These solutions must be able to be used universally, that is to say for road vehicle engines (particularly motor vehicles and heavy goods vehicles such as for example lorries, waste collection trucks, buses and coaches) and for non-road machinery and vehicle engines (particularly machinery intended for construction sites and/or public works such as bulldozers, off-road trucks; handling equipment; tractors and agricultural machines; boats; locomotives, etc.).

The patent application WO 2016/107889 describes the use of at least one C7-C30 alkane in a diesel fuel composition for reducing deposits on fuel injectors.

These alkanes are added to the fuel in variable amounts, in general a few percent, in order to reduce the dirty nature of the fuel, that is to say for an effect of preventing deposits on the injectors (keep-clean effect). This document does not relate to the problem of reducing deposits already present on the injectors, that is to say of cleaning dirty injectors.

### OBJECT OF THE INVENTION

The Applicant has now discovered that the use of a particular fuel composition, such as defined hereafter, would make it possible to effectively remedy the aforementioned problems, and particularly reduce the deposits present in the internal parts of a compression ignition engine (clean-up effect).

Thus, one object of the present invention is the use of a fuel composition comprising at least 85% by weight of one or more paraffinic hydrocarbon fractions consisting of one or more hydrotreated vegetable oils, said fraction(s) having a distillation range within the range from 100 to 400° C. and having a paraffin content greater than or equal to 90% by weight, for reducing the deposits present in the internal parts of a compression ignition engine.

Surprisingly, the Applicant observed that the use of such a composition in a dirty diesel engine would make it possible to clean it, that is to say very significantly eliminate the dirt generated by the prior use of classic diesel fuels.

This clean-up effect is obtained including in the absence of any detergent additive in the composition. It is therefore possible to formulate fuel compositions either totally devoid of detergent additive, or the detergent additive content of which is reduced in relation to classic diesel fuel compositions.

In addition, the compositions according to the invention have the advantage of having very good intrinsic properties, and particularly a low level of foaming and of demulsifying, a good cetane number, good resistance to cold in the case of isoparaffin-rich fractions (limited temperature of filterability and pour point). Thus, the use of such a composition makes it possible to limit or even entirely avoid the use of additives for improving the properties above.

The composition according to the invention may be used directly as fuel in vehicles and machinery equipped with a diesel engine, including the most sophisticated engines such as very high-pressure direct injection diesel engines.

The additional advantages associated with the use of the fuel composition according to the invention are:

an optimum functioning of the engine,

a reduction of the mass fuel consumption,

reduced CO2 emissions and pollutants, and

savings due to less engine maintenance.

According to a preferred first embodiment, the composition further comprises at least one first additive consisting of a quaternary ammonium salt, obtained by reaction with a quaternising agent of a nitrogen compound comprising a tertiary amine function, this compound being the product of the reaction of an acylating agent substituted by a hydrocarbon group and of a compound comprising at least one tertiary amine group and at least one group selected from primary amines, secondary amines and alcohols.

According to a preferred second embodiment, the composition further comprises at least one second additive consisting of an antioxidant agent selected from the compounds comprising a phenol group.

According to a particularly preferred third embodiment, the composition contains said first and second additives above.

The fuel composition according to the three embodiments above further have excellent anti-corrosion performances, and its use makes it possible to avoid the corrosion phenomenon both in the presence of fresh water and salty water. It also has an excellent level of stability and particularly a good stability during storage, a good thermal stability, and more generally a good resistance to oxidation.

Another object of the present invention is a method for cleaning the deposits present in the internal parts of the compression ignition engine, consisting of performing the combustion in said engine of a fuel composition such as defined in the present application.

Other objects, features, aspects and advantages of the invention will become more apparent upon reading the following description and examples.

In the following, and at least one other indication, the limits of a value range are included within this range, particularly in the expressions “between” and “ranging from . . . to . . . ”.

Moreover, the expressions “at least one” and “at least” used in the present description are respectively equivalent to the expressions “one or more” and “more than or equal to”.

Finally, in a manner known per se, CN compound or group designates a compound or a group containing in its chemical structure N carbon atoms.

### DETAILED DESCRIPTION

The Paraffinic Hydrocarbon Fraction

The composition used in accordance with the present invention comprises one or more hydrocarbon fractions having a distillation range within the range from 100 to 400° C. and having a paraffin content greater than or equal to 90% by weight, hereafter named “paraffinic hydrocarbon fraction”.

The distillation range of said paraffinic hydrocarbon fraction is determined in accordance with the standard NF EN ISO 3405. Preferably, it is within the range from 130 to 350° C., and more preferably from 150 to 320° C.

The paraffin content of this fraction is greater than or equal to 90% by weight, preferably greater than or equal to 95% by weight, even more preferably greater than or equal to 99% by weight, even better greater than or equal to 99.5% by weight, and even greater than or equal to 99.9% by weight, in relation to the total weight of said fraction.

“Paraffins” designates in a manner known per se, branched alkanes (also named isoparaffins or isoalkanes) and non-branched alkanes (also named n-paraffins or n-alkanes).

The paraffins present in the paraffinic hydrocarbon fraction(s) according to the invention advantageously comprise 10 to 20 carbon atoms. Preferably, they consist of at least 60% by weight, more preferably of at least 80% by weight and even better of at least 90% by weight of paraffins comprising from 12 to 18 carbon atoms, preferably from 14 to 18 carbon atoms, and even more preferably from 15 to 18 carbon atoms.

According to a preferred embodiment, the paraffinic hydrocarbon fraction(s) used in the composition according to the invention contain at least 50% by weight, preferably at least 70% by weight of isoparaffins, in relation to their total weight. According to a particularly preferred embodiment, they contain at least 90% by weight of isoparaffins.

The paraffinic hydrocarbon fraction(s) have an aromatic compound content preferably less than or equal to 10000 ppm by weight, more preferably less than or equal to 1500 ppm by weight, even more preferably less than or equal to 1000 ppm by weight.

Their naphthenic compound content is preferably less than or equal to 20000 ppm by weight, more preferably less than or equal to 10000 ppm by weight, and even better less than or equal to 1500 ppm by weight.

Their sulphur content is advantageously less than or equal to 10 ppm by weight, and even better less than or equal to 5 ppm by weight. Particularly preferably, this fraction is totally free of sulphur.

The paraffinic hydrocarbon fraction(s) used in the present invention are hydrotreated vegetable oils, also known as HVO. These are oils of vegetable origin that have undergone successive treatments including a hydrotreatment then a possible isomerisation.

Examples of suitable vegetable raw materials comprise rapeseed oil, canola oil, sunflower seed oil, soya oil, hempseed oil, olive oil, linseed oil, mustard oil, palm oil, castor oil, coconut oil.

The patent applications WO2016/185046 and WO2016/185047 describe hydrotreated vegetable oils and their preparation, which consist of examples of isoparaffinic hydrocarbon fractions particularly suitable for the compositions subject matter of the present invention.

The composition used in accordance with the present invention comprises at least 85% by weight of one or more paraffinic hydrocarbon fractions such as described above. Preferably, it contains at least 90% by weight of one or more paraffinic hydrocarbon fractions, more preferably at least 93% by weight.

According to one embodiment, the composition contains at least 95% by weight, preferably at least 99% by weight, and even better at least 99.5% by weight of one or more paraffinic hydrocarbon fractions such as described above.

The First Additive (Quaternary Ammonium Salt), Optional:

Preferably, the fuel composition used in accordance with the present invention further comprises an additive (hereafter named “first additive”) consisting of a quaternary ammonium salt, obtained by reaction with a quaternising agent of a nitrogen compound comprising a tertiary amine function, this nitrogen compound being the product of the reaction of an acylating agent substituted by a hydrocarbon group and of a compound comprising at least one tertiary amine group and at least one group selected from primary amines, secondary amines and alcohols.

Said nitrogen compound is the product of the reaction of an acylating agent substituted by a hydrocarbon group and of a compound comprising both an oxygen atom or a nitrogen atom capable of condensing with said acylating agent and a tertiary amine group.

The acylating agent is, advantageously, selected from mono- or poly-carboxylic acids and their derivatives, particularly their ester, amide or anhydride derivatives. The acylating agent is preferably selected from succinic, phthalic and propionic acids and the corresponding anhydrides.

The acylating agent is substituted by a hydrocarbon group. “Hydrocarbon” group means any group having a carbon atom attached directly to the rest of the molecule (i.e. to the acylating agent) and mainly having an aliphatic hydrocarbon nature.

Hydrocarbon groups according to the invention may also contain non-hydrocarbon groups. For example, they may contain up to one non-hydrocarbon group per ten carbon atoms provided that the non-hydrocarbon group does not significantly alter the mainly hydrocarbon nature of the group. By way of example such groups well known to the person skilled in the art, the hydroxyl groups, the halogens (in particular the chloro- and fluoro-groups), the alkoxy, alkylmercapto, alkylsulphoxy groups can be cited.

Nevertheless, preference will be given to hydrocarbon substitutes that do not contain such non-hydrocarbon groups and having a purely aliphatic hydrocarbon nature.

The hydrocarbon substituant of the acylating agent comprises, preferably, at least 8, preferably, at least 12 carbon atoms. Said hydrocarbon substitute may comprise up to approximately 200 carbon atoms.

The hydrocarbon substituant of the acylating agent has, preferably, a number average molecular weight (Mn) between 170 and 2800, for example between 250 and 1500, more preferably between 500 and 1500 and, even more preferably between 500 and 1100. An Mn value range between 700 and 1300 is particularly preferred, for example from 700 to 1000.

By way of example of hydrocarbon groups substituting the acylating agent, the n-octyl, n-decyl, n-dodecyl, tetrapropenyl, n-octadecyl, oleyl, octadecyl or triacontyl groups can be cited.

The hydrocarbon substituant of the acylating agent may also be obtained from homo- or inter-polymers (for example copolymers, terpolymers) of mono- and di-olefins having from 2 to 10 carbon atoms, for example from ethylene, propylene, 1-butene, isobutene, butadiene, isoprene, 1-hexene or 1-octene. Preferably, these olefins are 1-mono-olefins.

The hydrocarbon substituant of the acylating agent may also be selected from the halogenated analogue (for example chlorinated or brominated) derivatives of these homo- or inter-polymers.

According to one variant, the hydrocarbon substituant of the acylating agent may be obtained from other sources, for example from high-molecular weight alkene monomers (for example, 1-tetracontene) and their chlorinated or hydrochlorinated analogues, of aliphatic oil fractions, for example paraffin waxes, their cracked, chlorinated and/or hydrochlorinated analogues, white oil, synthetic alkenes, for example produced by Ziegler-Natta process (for example polyethylene greases) and other sources known to the person skilled in the art.

Any unsaturation present in the hydrocarbon group of the acylating agent may optionally be reduced or eliminated by hydrogenation according to any known process.

The hydrocarbon substituant of the acylating agent is, preferably, essentially saturated, that is to say that it does not contain more than one carbon-carbon unsaturated bond for each section of ten carbon-carbon single bonds present.

The hydrocarbon substituant of the acylating agent, advantageously, does not contain more than one non-aromatic carbon-carbon unsaturated bond every 50 carbon-carbon bonds present.

According to a preferred embodiment, the hydrocarbon substituant of the acylating agent is a polyisobutene (PIB) group. So-called highly reactive polyisobutenes (PIB) are most particularly preferred. Highly reactive polyisobutenes (PIB) means polyisobutenes (PIB) wherein at least 50% by moles, preferably at least 70% by moles or more, of the terminal olefinic double bonds are of the vinylidene type as described in the document EP0565285. In particular, the preferred PIB are those having more than 80% by moles and up to 100% by moles of terminal vinylidene groups such as described in the document EP1344785.

According to a particularly preferred embodiment, the acylating agent substituted by a hydrocarbyl group is a polyisobutenyl succinic anhydride (PIBSA).

The preparation of polyisobutenyl succinic anhydrides is known per se, and broadly described in the literature. By way of example it can be cited the processes comprising the reaction between polyisobutenes (PIB) and maleic anhydride described in the documents U.S. Pat. Nos. 3,361,673 and 3,018,250 or the process comprising the reaction of a halogenated, in particular chlorinated, polyisobutene (PIB) with maleic anhydride (U.S. Pat. No. 3,172,892).

According to one variant, polyisobutenyl succinic anhydride may be prepared by mixing a polyolefin with maleic anhydride then by passing chlorine through the mixture (GB949981).

Other hydrocarbon groups comprising an internal olefin, for example such as those described in the application WO2007/015080, may also be used as a substituant for the acylating agent. Internal olefin means any olefin mainly containing a non-alpha double bond, which is a beta olefin or of higher position.

Preferably, these materials are essentially beta-olefins or olefins of higher position, for example containing less than 10% by mass of alpha-olefin, advantageously less than 5% by mass or less than 2% by mass.

The internal olefins may be prepared by isomerisation of alpha-olefins according to any known process.

The compound comprising both an oxygen atom or a nitrogen atom capable of condensing with the acylating agent and a tertiary amine group may, for example, be selected from the group consisting of: N,N-dimethylaminopropylamine, N,N-diethylaminopropylamine, N,N-dimethylamino-ethylamine. Said compound may furthermore be selected from the heterocyclic compounds substituted by alkylamines such as 1-(3-aminopropyl)imidazole and 4-(3-aminopropyl)morpholine, 1-(2-aminoethyl)piperidine, 3,3-diamino-N-methyldipropylamine, and 3′3-bisamino(N,N-dimethylpropylamine).

The compound comprising both an oxygen atom or a nitrogen atom capable of condensing with the acylating agent and a tertiary amine group may also be selected from the alkanolamines, including, but not limited to, triethanolamine, trimethanolamine, N,N-dimethylaminopropanol, N,N-dimethylaminoethanol, N,N-diethylaminopropanol, N,N-diethylaminoethanol, N,N-diethylaminobutanol, N,N,N-tris(hydroxyethyl)amine, N,N,N-tris(hydroxymethyl)amine, N,N,N tris(aminoethyl)amine, N,N-dibutylaminopropylamine and N,N,N′-trimethyl-N′-hydroxyethyl-bisaminoethyl ether, N,N-bis(3-dimethylamino-propyl)-N-isopropanolamine, N-(3-dimethylamino-propyl)-N,N-diisopropanolamine, N′-(3-(Dimethylamino)propyl)-N,N-dimethyl-1,3-propanediamine; 2-(2-dimethylaminoethoxy)ethanol and N,N,N′-trimethylaminoethylethanolamine.

According to a preferred embodiment, said compound comprising at least one tertiary amine group and at least one group selected from primary amines, secondary amines and alcohols is selected from the following amines of formula (I) or (II):

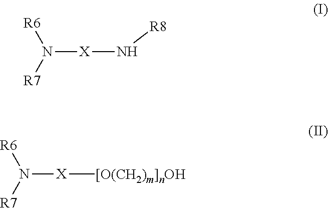

wherein:

R6 and R7 are identical or different and represent, independently from one another, an alkyl group having from 1 to 22 carbon atoms;
X is an alkylene group having from 1 to 20 carbon atoms;
m is an integer between 1 and 5;
n is an integer between 0 and 20; and
R8 is a hydrogen atom or a C1 to C22 alkyl group.

When the nitrogen compound comprises an amine of formula (I), R8 is advantageously a hydrogen atom or a C1 to C16 alkyl group, preferably a C1 to C10 alkyl group, even more preferably a C1 to C6 alkyl group. R8 may, for example, be selected from the group consisting of hydrogen, methyl, ethyl, propyl, butyl and their isomers. Preferably R8 is a hydrogen atom.

When the nitrogen compound comprises an amine of formula (II), m is preferably equal to 2 or 3, more preferably equal to 2; n is preferably an integer between 0 and 15, more preferably between 0 and 10, even more preferably between 0 and 5. Advantageously, n is 0.

According to a preferred embodiment, said nitrogen compound is the product of the reaction of the acylating agent substituted by a hydrocarbon group and of a diamine of formula (I).

In this embodiment:

R6 and R7 may represent, independently from one another, a C1 to C16 alkyl group, preferably a C1 to C10 alkyl group;

R6 and R7 may represent, independently from one another, a methyl, ethyl, propyl, butyl, pentyl, hexyl, heptyl, octyl group or their isomers. Advantageously, R6 and R7 represent independently from one another, a C1 to C4 group, preferably a methyl group;

X represents an alkylene group having 1 to 16 carbon atoms, preferably from 1 to 12 carbon atoms, more preferably from 1 to 8 carbon atoms, for example from 2 to 6 carbon atoms or from 2 to 5 carbon atoms. X particularly preferably represents an ethylene, propylene or butylene group, in particular a propylene group.

According to a particularly preferred embodiment, the nitrogen compound is the product of reaction of a succinic acid derivative substituted by a hydrocarbon group, preferably a polyisobutenyl succinic anhydride, and of an alcohol or of an amine also including a tertiary amine group, particularly a compound of formula (I) or (II) such as described above and more preferably a compound of formula (I).

According to a first variant, the succinic acid derivative substituted by a hydrocarbon group reacts with the amine also comprising a tertiary amine group under certain conditions to form a succinimide (closed form). The reaction of the succinic acid derivative and of the amine may also lead under certain conditions to a succinamide, that is to say, a compound comprising an amide group and a carboxylic acid group (open form).

According to a second variant, an alcohol also comprising a tertiary amine group reacts with the succinic acid derivative to form an ester also comprising a carboxyl group—free CO2H (open form). Thus, in some embodiments the nitrogen compound may be the product of reaction of a succinic acid derivative and of an amine or an alcohol that is an ester or an amide and that further comprises also a carboxyl-CO2H group not having reacted (open form).

The quaternary ammonium salt forming the second additive according to the present invention is obtained directly by reaction between the nitrogen compound described above comprising a tertiary amine function and a quaternising agent.

According to a particular embodiment, the quaternising agent is selected from the group consisting of dialkyl sulphates, carboxylic acid esters, alkyl halides, benzyl halides, hydrocarbon carbonates, and hydrocarbon epoxides optionally mixed with an acid, alone or in a mixture.

For fuel applications, it is often desirable to reduce the content of halogen, sulphur and the compounds containing phosphorus.

Thus, if a quaternising agent containing such an element is used, it may be advantageous to perform a subsequent reaction to exchange the counterion. For example, a quaternary ammonium salt formed by reaction with an alkyl halide may then be reacted with sodium hydroxide and the sodium halide salt eliminated by filtration.

The quaternising agent may comprise halides such as chloride, iodide or bromide; hydroxides; sulphonates; bisulphites; alkyl sulphates such as dimethyl sulphate; sulphones; phosphates; C1-C12 alkyl phosphates; C1-C12 dialkyl phosphates; borates; C1-C12 alkyl borates; nitrites; nitrates; carbonates; bicarbonates; alkanoates; C1-C12 O,O-dialkyldithiophosphates, alone or in a mixture.

According to a particular embodiment, the quaternising agent may be selected from dialkyl sulphate derivatives such as dimethyl sulphate, N-oxides, sulphones such as propane- and butane-sulphone, alkyl, acyl or aralkyl halides such as methyl and ethyl chloride, benzyl bromide, iodide or chloride, and hydrocarbon carbonates (or alkyl carbonates).

If the acyl halide is benzyl chloride, the aromatic ring is optionally substituted by one or more alkyl or alkenyl groups.

The hydrocarbon groups (alkyls) of hydrocarbon carbonates may contain from 1 to 50, from 1 to 20, from 1 to 10 or 1 to 5 carbon atoms per group. According to one embodiment, the hydrocarbon carbonates contain two hydrocarbon groups that may be identical or different. By way of example of hydrocarbon carbonates, dimethyl or diethyl carbonate can be cited.

According to a preferred embodiment, the quaternising agent is selected from the hydrocarbon epoxides represented by the following formula (III):

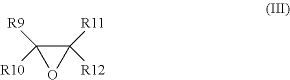

wherein R9, R10, R11 and R12 may be identical or different and represent independently from one another a hydrogen atom or a C1 to C50 hydrogen group. By way of non-limiting example, styrene oxide, ethylene oxide, propylene oxide, butylene oxide, stilbene oxide and C1 to C50 epoxides can be cited. Styrene oxide and propylene oxide are particularly preferred.

Such hydrocarbon epoxides may be used as quaternising agent in combination with an acid, for example with acetic acid. The hydrocarbon epoxides may also be used alone as a quaternising agent, particularly without supplementary acid. Without being bound by this hypothesis, it would seem that the presence of the carboxylic acid function in the molecule promotes the formation of the quaternary ammonium salt. In such an embodiment not using supplementary acid, a protic solvent is used for the preparation of the quaternary ammonium salt. By way of example, protic solvents such as water, alcohols (including polyhydric alcohols) may be used alone or in a mixture. Preferred protic solvents have a dielectric constant greater than 9.

Corresponding quaternary ammonium salts prepared from amides or esters and succinic acid derivatives are described in WO2010/132259.

According to another embodiment, the quaternising agent is selected from the compounds of formula (IV):

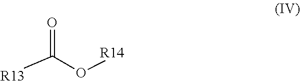

wherein R13 is an alkyl, alkenyl, aryl and aralkyl group optionally substituted, and R14 is a C1 to C22 alkyl, aryl or alkyl aryl group.

The compound of formula (IV) is a carboxylic acid ester able to react with a tertiary amine to form a quaternary ammonium salt. Compounds of formula (IV) are selected, for example from carboxylic acid esters having a pKa of 3.5 or less. The compound of formula (IV) is, preferably, selected from substituted aromatic carboxylic acid, alpha-hydroxycarboxylic acid and polycarboxylic acid esters.

According to one embodiment, the ester is a substituted aromatic carboxylic acid ester of formula (IV) wherein R13 is a substituted aryl group. Preferably, R13 is a substituted aryl group having 6 to 10 carbon atoms, preferably a phenyl or naphthyl group, more preferably a phenyl group. R13 is advantageously substituted by one or more groups selected from the carboalcoxy, nitro, cyano, hydroxy, SR15 and NR15R16 radicals. Each of the R15 and R16 groups may be a hydrogen atom or an alkyl, alkenyl, aryl or carboalcoxy group optionally substituted. Each of the R15 and R16 groups represents, advantageously, the hydrogen atom or a C1 to C22 alkyl group optionally substituted, preferably the hydrogen atom or a C1 to C16 alkyl group, more preferably the hydrogen atom or a C1 to C10 alkyl group, even more preferably the hydrogen atom or a C1 to C4 alkyl group. R15 is preferably a hydrogen atom and R16 a hydrogen atom or a C1 to C4 group, advantageously, R15 and R16 are both a hydrogen atom.

According to one embodiment, R13 is an aryl group substituted by one or more groups selected from hydroxyl, carboalcoxy, nitro, cyano and NH2 radicals. R13 may be a polysubstituted aryl group, for example trihydroxyphenyl. Advantageously, R13 is a monosubstituted aryl group, preferably ortho substituted. R13 is, for example, substituted by a group selected from the OH, NH2, NO2 or COOMe radicals, preferably OH or NH2. R13 is, preferably, a hydroxy-aryl group, in particular 2-hydroxyphenyl.

According to a particular embodiment, R14 is an alkyl or alkyl aryl group. R14 may be a C1 to C16, preferably C1 to C10, advantageously C1 to C8 alkyl group. R14 may be a C1 to C16, preferably C1 to C10, advantageously C1 to C8 alkyl aryl group. R14 may for example be selected from the methyl, ethyl, propyl, butyl, pentyl, benzyl groups or their isomers. Preferably, R14 is a benzyl or methyl group, more preferably methyl.

A particularly preferred compound is methyl salicylate.

According to a particular embodiment, the compound of formula (IV) is an ester of an alpha-hydroxycarboxylic acid corresponding to the following formula (V):

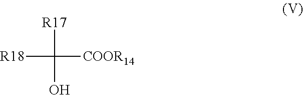

wherein R17 and R18 are identical or different and are independently selected from the group consisting of the hydrogen atom, the alkyl, alkenyl, aryl or aralkyl groups. Such compounds are for example described in the document EP 1254889.

Examples of compounds of formula (IV) wherein R13COO is the residue of an alpha-hydroxycarboxylic acid comprise methyl-, ethyl-, propyl-, butyl-, pentyl-, hexyl-, phenyl-, benzyl- or allyl-esters of 2-hydroxyisobutyric acid; methyl-, ethyl-, propyl-, butyl-, pentyl-, hexyl-, benzyl-, phenyl- or allyl-esters of 2-hydroxy-2-methylbutyric acid; methyl-, ethyl-, propyl-, butyl-, pentyl-, hexyl-, benzyl-, phenyl- or allyl-esters of 2-hydroxy-2-ethylbutyric acid; methyl-, ethyl-, propyl-, butyl-, pentyl-, hexyl-, benzyl-, phenyl- or allyl-esters of lactic acid and methyl-, ethyl-, propyl-, butyl-, pentyl-, hexyl-, allyl-, benzyl- or phenyl-esters of glycolic acid. From the preceding, the preferred compound is methyl-2-hydroxyisobutyrate.

According to a particular embodiment, the compound of formula (IV) is an ester of a polycarboxylic acid selected from dicarboxylic acids and carboxylic acids having more than two acid functions. The carboxylic functions are preferably all in esterified form. The preferred esters are C1 to C4 alkyl esters.

The compound of formula (IV) may be selected from oxalic acid diesters, phthalic acid diesters, maleic acid diesters, malonic acid diesters or citric acid diesters. Preferably, the compound of formula (IV) is dimethyl oxalate.

According to a preferred variant, the compound of formula (IV) is a carboxylic acid ester having a pKa less than 3.5. For the case where the compound comprises more than one acid group, reference will be made to the first dissociation constant.

The compound of formula (IV) may be selected from one or more carboxylic acid esters selected from oxalic acid, phthalic acid, salicylic acid, maleic acid, malonic acid, citric acid, nitrobenzoic acid, aminobenzoic acid and 2,4,6-trihydroxybenzoic acid. The preferred compounds of formula (IV) are dimethyl oxalate, methyl 2-nitrobenzoate and methyl salicylate.

According to a particularly preferred embodiment, the quaternary ammonium salt used in the invention is formed by reaction of a hydrocarbon epoxide, preferably selected from those of formula (III) above and more preferably propylene oxide, with the product of the reaction of a polyisobutenyl succinic anhydride the polyisobutylene (PIB) group of which has a number average molecular weight (Mn) between 700 and 1000 and of dimethylaminopropylamine.

The fuel composition used according to the invention may advantageously comprise the first additive(s) such as described above with a preferred content ranging from 5 to 1000 ppm, preferably from 10 to 500 ppm, and more preferably from 50 to 200 ppm by weight, in relation to the total weight of the composition.

The Second Additive (Phenolic Antioxidant Agent), Optional:

Preferably, the fuel composition used in accordance with the present invention further comprises an additive (hereafter named as “second additive”) consisting of an antioxidant agent selected from the compounds comprising in their structure a phenol group.

The name “second additive” is used in the present application only for the purposes of differentiating this from the first additive described above. This expression must not be interpreted in a limiting way, as meaning that the composition containing said second additive necessarily also contains said first additive. In other terms, the composition used in accordance with the present invention may contain one and/or the other of the said first and second additives.

According to a particularly preferred embodiment, the fuel composition contains at least one first and at least once second additive such as described in the present application.

Antioxidant agents that can be used as a second additive are selected from di-t-butyl-2,6 methyl-4 phenol (BHT), t-butyl hydroquinone (TBHQ), 2,6 and 2,4 di-t-butyl phenol, 2,4-dimethyl-6-t-butyl phenol, pyrogallol, tocopherol, 4,4′-methylenebis(2,6-di-t-butyl phenol) (CAS No. 1 18-82-1), alone or in a mixture.

Particularly preferred antioxidant agents are selected from alkyl phenols such as in particular di-t-butyl-2,6 methyl-4 phenol (BHT).

The fuel composition used according to the invention may advantageously comprise the second additive(s) such as described above with a preferred content ranging from 2 to 500 ppm, preferably from 5 to 250 ppm, and more preferably from 10 to 150 ppm by weight, in relation to the total weight of the composition.

The Other Additives:

The fuel composition used in accordance with the present invention may also comprise one or more additional additives, different from the first and second additives such as described above.

According to a preferred embodiment, the composition further comprises one or more amino antioxidant agents, which particularly may be selected from aliphatic, cycloaliphatic and aromatic amines. Dicyclohexylamine is particularly preferred.

The amino antioxidant agent(s) may be present in a content ranging from 0.2 to 50 ppm, preferably from 0.5 to 25 ppm, and more preferably from 1 to 20 ppm by weight, in relation to the total weight of the composition.

According to a preferred embodiment, the composition further comprises one or more metal passivator agents, selected from the triazole derivatives, alone or in a mixture.

“Triazole derivatives” means all of the compounds comprising a triazole unit, that is to say a 5-member aromatic cyclic unit, comprising two double bonds and 3 nitrogen atoms. According to the position of the nitrogen atoms, 1,2,3-triazole units (known as V-triazoles) and 1,2,4-triazole units (known as S-triazoles) are distinguished. By way of example of triazole units, benzotriazole or tolyltriazole can be cited.

The metal passivator agent(s) are preferably selected from amines substituted by triazole groups, alone or in a mixture. “Triazole group” means any substitute containing a triazole unit such as defined above.

The metal passivator agent(s) are more preferably selected from N,N-bis(2-ethylhexyl)-[(1,2,4-triazol-1-yl)methyl]amine (CAS 91273-04-0) and N,N-bis(2-ethylhexyl)-4-methyl-1H-benzotriazole-1-methylamine (CAS 80584-90-3), alone or in a mixture.

It can also be cited and the passivator agents described on page 5 of the application US 2006/0272597.

The metal passivator agent(s) may be present in a content ranging from 0.2 to 50 ppm, preferably from 0.5 to 25 ppm, and more preferably from 1 to 15 ppm by weight, in relation to the total weight of the composition.

According to another preferred embodiment, the composition further comprises one or more chelating agents (or metal sequestering agents), which may particularly be selected from amines substituted by N,N′-disalicylidene groups, such as N,N′-disalicylidene 1,2-diaminopropane (DMD).

The chelating agent(s) may be present in a content ranging from 0.1 to 100 ppm, preferably from 0.2 to 50 ppm, and more preferably from 0.5 to 20 ppm by weight, even more preferably from 0.5 to 10 ppm by weight, in relation to the total weight of the composition.

The composition according to the invention may also comprise one or more other additives currently used in fuels, different from the additives described previously.

The composition may, typically, comprise one or more other additives selected from detergents, anti-corrosion agents, dispersants, demulsifiers, tracers, biocides, reodorants, procetane additives, friction modifiers, lubricity additives or oiliness additives, combustion-aid agents (soot combustion catalytic promoters), anti-wear agents and/or conductivity-modifying agents.

From these additives, the following in particular can be cited:

a) procetane additives, particularly (but not limited to) selected from alkyl nitrates, preferably 2-ethylhexyl nitrate, aryl peroxides, preferably benzyl peroxide, and alkyl peroxides, preferably di-tert-butyl peroxide;
b) lubricity additives or anti-wear agents, particularly (but not limited to) selected in the group consisting of fatty acids and their ester or amide derivatives, particularly glycerol monooleate, and mono- and polycyclic carboxylic acid derivatives. Examples of such additives are given in the following documents: EP680506, EP860494, WO98/04656, EP915944, FR2772783, FR2772784,
c) demulsifying additives for example (but not limited to) selected from oxyalkylated phenolic alkyl resins (for example the compound CAS 63428-92-2)
d) detergents.

According to a preferred embodiment, the composition comprises at least one detergent additive selected from the triazole derivatives of following formula (VI):

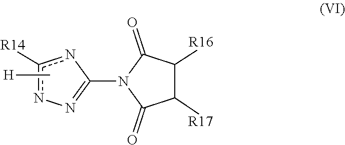

wherein

R14 is selected from the group consisting of a hydrogen atom, a linear or branched C1 to C8, preferably C1 to C4, more preferably C1 to C2, aliphatic hydrocarbon group and a carboxyl group (—CO2H). Preferably, R14 is a hydrogen atom;

R16 and R17 are identical or different and represent, independently from one another, a group selected from the group consisting of a hydrogen atom and an cyclic or acyclic, saturated or unsaturated, linear or branched aliphatic hydrocarbon group having from 2 to 200 carbon atoms, preferably from 14 to 200 carbon atoms, more preferably from 50 to 170 carbon atoms, even more preferably between 60 and 120 carbon atoms.

It should be noted that we apply the conventional representation rules (bond in dotted line and labile bond) to indicate that the position of the hydrogen atom and of the double bond in the triazole cycle may change, said formula thus covering the two possible positions.

According to a particular embodiment, the triazole derivative has the formula (VI) wherein R16 and R17 are identical or different and represent, independently from one another, a group selected from the group consisting of a hydrogen atom and an aliphatic hydrocarbon group having a number average molecular weight (Mn) between 200 and 3000, preferably between 400 and 3000, more preferably between 400 and 2500, even more preferably between 400 and 1500 or between 500 and 1500. Said aliphatic hydrocarbon group is preferably a polyisobutylene (or also known as polyisobutene noted PIB) group having a number average molecular weight (Mn) between 200 and 3000, preferably between preferably between 5400 and 3000, more preferably between 400 and 2500, even more preferably between 400 and 1500 or between 500 and 1500. According to a particularly preferred embodiment, R16 and R17 represent respectively a hydrogen atom and a PIB group such as described above or vice versa.

According to a preferred embodiment, the composition used in accordance with the invention does not contain an anti-foam additive. Indeed, the correct intrinsic properties of the composition according to the invention make the addition of such an additive unnecessary. As a reminder, examples of anti-foam additives are particularly (but not limited to) polysiloxanes, oxyalkylated polysiloxanes, and fatty acid amides obtained from vegetable or animal oils. Examples of such additives are given in EP861882, EP663000, EP736590.

The Use:

According to the present invention, the fuel composition such as described above is used for reducing the deposits present in the internal parts of a compression ignition engine (or diesel engine). This is a cleaning effect of the dirty internal parts, or a so-called “clean-up” effect.

The parts of the engine cleaned by the use of the composition according to the invention are advantageously selected from the following: the combustion chamber and the fuel injection system.

The deposits most particularly targeted are located in the injection system of the diesel engine, preferably, located on an external part of an injector of said injection system, for example the nose of the injector and/or on an internal part of an injection of said injection system (IDID—Internal Diesel Injector Deposits), for example at the surface of an injector needle.

The deposits eliminated by the use according to the invention may be of any type, and in particular the deposits related to the coking phenomenon and/or the soap and/or lacquering type deposits.

The clean-up effect of the internal parts of diesel engines induced by the use according to the invention may be evaluated by various methods, well known to the person skilled in the art. By way of non-limiting example, it will be cited the tests standardised or recognised by the profession or the methods described in the following literature:

the DW10 method, a CEC F-98-08 standardised engine test method, consisting of measuring the power loss due to the formation of deposits in the internal parts of a direct injection diesel engine;

the XUD9 method, a CEC F-23-1-01 Issue 5 standardised engine test method, consisting of measuring the fuel flow restriction emitted by the injector;

the method described by the applicant in application WO2014/029770 page 17 to 20, consisting of evaluating lacquering deposits (IDID).

According to a particular embodiment, the use according to the invention makes it possible to reduce the mass fuel consumption of the internal combustion engine.

According to a particular embodiment, the use according to the invention makes it possible to reduce pollutant emissions, in particular particle emissions of the internal combustion engine.

The composition according to the invention may be used for cleaning any type of diesel engine, equipping any vehicle or stationary machinery, and for example to clean the engines of the following vehicles: light duty vehicles, heavy goods vehicles (lorries of various loads known as “medium duty” and “heavy duty”, household waste collection trucks, buses, coaches, etc.), and non-road vehicles (for example construction and/or public works machinery, tractors, trains, boats).

According to a preferred embodiment, the composition is used for cleaning the internal parts of a motor vehicle diesel engine, preferably a Direct Injection Compression Ignition (DICI) engine, in particular a Common Rail Direct Injection (CRDI) engine.

The examples hereafter are given by way of illustration of the invention, and shall not be interpreted so as to limit its scope.

### EXAMPLES

The examples hereafter have been produced from a paraffinic hydrocarbon fraction (C1 fraction hereafter) consisting of a hydrotreated vegetable oil (HVO) the features of which are detailed in Table I below:

TABLE I

| Feature | Method | Value | |
|---|---|---|---|
| Density at 15° C. | ISO 12185 | 779.9 | kg/m3 |
| Viscosity at 40° C. | ISO 3104 | 2.9 | mm2/s |
| Cloud point (CP)° | ASTM D7346 | −36° | C. |
| Cold filter plugging point | EN 116 | −39° | C. |
| (CFPP) | | | |
| Boiling profile | ISO 3405 | | |
| | Initial point | 216.0° | C. |
| | Point at 5% vol. | 252.4° | C. |
| | Point at 10% vol. | 262.1° | C. |
| | Point at 20% vol. | 269.8° | C. |
| | Point at 30% vol. | 273.4° | C. |
| | Point at 40% vol. | 275.7° | C. |
| | Point at 50% vol. | 277.8° | C. |
| | Point at 60% vol. | 279.7° | C. |
| | Point at 70% vol. | 282.1° | C. |
| | Point at 80% vol. | 285.0° | C. |
| | Point at 90% vol. | 289.2° | C. |
| | Point at 95% vol. | 293.0° | C. |
| | Final point | 304.3° | C. |
| | Boiled volume | 98.6 | ml |
| | Residue | 1.3 | ml |
| | Losses | 0.1 | ml |

| | | |
|---|---|---|
| Aromatic compound content | EN12916 | 0% by weight |

This hydrocarbon fraction consists of 99.9% by weight of paraffins, of which 92.6% of isoparaffins (hereafter i-paraffins) and 7.3% by weight of n-paraffins.

Its exact composition is detailed in Table II below:

TABLE II

| Number of | | | | |
|---|---|---|---|---|
| C atoms | n-paraffins | i-paraffins | naphthenes | i-naphthenes |
| 7 | 2.35 | 0.39 | | |
| 8 | 0.09 | 0.20 | 0.01 | |
| 9 | 0.16 | 0.43 | | 0.01 |
| 10 | 0.17 | 0.80 | | 0.01 |
| 11 | 0.14 | 0.84 | | |
| 12 | 0.13 | 0.99 | | |
| 13 | 0.15 | 1.02 | | |
| 14 | 0.86 | 1.54 | 0.01 | 0.01 |
| 15 | | 9.55 | 0.01 | 0.05 |
| 16 | 2.43 | 31.15 | | 0.01 |
| 17 | | 14.22 | | |
| 18 | 0.80 | 30.71 | | 0.02 |
| 19 | | 0.23 | | 0.01 |
| 20 | 0.01 | 0.31 | | |
| 21 | | 0.03 | | |
| 22 | | 0.06 | | |
| 23 | | 0.02 | | |
| 24 | | 0.01 | | |
| 27 | | 0.08 | | |
| Total | 7.29 | 92.56 | 0.03 | 0.12 |

C2 and C3 fuel compositions have been prepared, by adding to the C1 fraction the additives detailed in Table III below, wherein the content of each additive is indicated in ppm by weight in relation to the total weight of the final composition:

TABLE III

| Additives added | C2 composition | C3 composition |
|---|---|---|
| Additive 1: quaternary | 100 | 137 |
| ammonium salt 1 | | |
| Composition 2 | 0 | 164 |

(1) formed by reaction of propylene oxide with the product of the reaction of a polyisobutenyl succinic anhydride the polyisobutylene (PIB) group of which has a number average molecular weight (Mn) of 1000 g/mol and of dimethylaminopropylamine;

(2) additive composition consisting of di-t-butyl-2,6 methyl-4 phenol; dicyclohexylamine; N,N-bis(2-ethylhexyl)-[(1,2,4-triazol-1-yl)methyl]amine; and N,N′-disalicylidene 1,2-diaminopropane.

The detergent properties of the fuel composition consisting of the C1 hydrocarbon fraction alone, and C2 and C3 compositions have been evaluated.

The performances in terms of detergency have been evaluated by using the XUD9 engine test, consisting of determining the loss of flow defined as corresponding to the restriction of the flow of a diesel fuel emitted by the injector of a pre-chamber diesel engine during its functioning, according to the CEC F-23-1-01 standardised engine test method. The aim of this test is to evaluate the capability of the composition of additives tested to reduce the deposits on the injectors of a Peugeot XUD9 A/L four cylinder and diesel pre-chamber injection engine.

The tests have been performed with a Peugeot XUD9 A/L four cylinder and diesel pre-chamber injection engine equipped with clean injectors of which the flow was determined beforehand.

The engine follows the test cycle detailed in the following Table IV repeated 134 times for a total duration of 10 hours and 3 minutes:

TABLE IV

| Step | Duration (s) | Speed (rpm) | Torque (Nm) |
|---|---|---|---|
| 1 | 30 | 1200 ± 30 | 10 ± 2 |
| 2 | 60 | 3000 ± 30 | 50 ±2 |
| 3 | 60 | 1300 ± 30 | 35 ± 2 |
| 4 | 120 | 1850 ± 30 | 50 ± 2 |

The test conditions are the following:

Coolant flow (step 2 only): 85±5 l/min

### Temperatures:

Coolant outflow: 95±2° C.

Oil: 100±5° C.

Air intake: 32±2° C.

Fuel (at the pump): 31±2° C.

### Pressures:

At the inlet of the fuel pump: −50 to +100 mbar

At the outlet of the fuel pump: −100 to +100 mbar

Exhaust discharge pressure (step 2 only): 50±10 mbar

air intake: 950±10 mbar.

The following two consecutive phases have been performed, with the same test method for each phase:

Phase 1 of dirty up with a conventional diesel fuel of B7 type, in accordance with the standard EN 590. The loss of flow evaluated after this first phase is of 80%.

Phase 2 of clean up with the candidate fuel.

At the end of the test, the flow of the injectors is again evaluated. The loss of flow is measured on the four injectors. The results are expressed as a percentage of loss of flow for various needle lifts. Usually the dirty-up values at 0.1 mm of needle lift are compared because they are more discriminating and more accurate and repeatable (repeatability <5%). The evolution of the loss of flow before/after test makes it possible to deduce the loss of flow as a percentage. Given the repeatability of the test, a significant detergent effect can be confirmed for a reduction of loss of flow i.e. a gain in flow greater than 10 points (>10%).

At the end of the test and after the cleaning phase, the loss of flow of the injectors is again evaluated.

The results obtained are detailed in Table V below:

TABLE V

| Composition | C1 | C2 | C3 |
|---|---|---|---|
| Loss of flow (%) | 59 | 3 | 0 |

The results above show that the composition according to the invention leads to very good results in terms of cleaning dirty injectors (clean-up effect).

Indeed, the use of the composition consisting of the C1 fraction alone makes it possible to reduce the loss of flow by 21% (80-59), which means that a substantial portion of the deposits present at the surface of the injectors have been eliminated.

The use of the C2 and C3 compositions, which contain a low content of Additive 1 (detergent additive) makes it possible to further increase this effect, and to obtain complete elimination of the deposits (zero or almost zero loss of flow).

1. A use, for reducing the deposits present in the internal parts of a compression ignition engine, of a fuel composition comprising at least 85% by weight of one or more paraffinic hydrocarbon fractions consisting of one or more hydrotreated vegetable oils, said fraction(s) having a distillation range within the range from 100 to 400° C. and having a paraffin content greater than or equal to 90% by weight.

2. The use according to claim 1, characterised in that the distillation range of said paraffinic hydrocarbon fraction is within the range from 130 to 350° C.

3. The use according to claim 1, characterised in that the paraffin content of said paraffinic hydrocarbon fraction is greater than or equal to 95% by weight, in relation to the total weight of said fraction.

4. The use according to claim 1, characterised in that said paraffinic hydrocarbon fraction contains at least 50% by weight of isoparaffins, in relation to the weight of said fraction.

5. The use according to claim 1, characterised in that the fuel composition comprises at least 90% by weight of said paraffinic hydrocarbon fraction(s).

6. The use according to claim 1, characterised in that the fuel composition further contains at least one first additive consisting of a quaternary ammonium salt, obtained by reaction with a quaternising agent of a nitrogen compound comprising a tertiary amine function, this compound being the product of the reaction of an acylating agent substituted by a hydrocarbon group and of a compound comprising at least one tertiary amine group and at least one group selected from primary amines, secondary amines and alcohols.

7. The use according to claim 6, characterised in that the acylating agent substituted by a hydrocarbon group is a polyisobutenyl succinic anhydride.

8. The use according to claim 6, characterised in that said compound comprising at least one tertiary amine group and at least one group selected from primary amines, secondary amines and alcohols is selected from the following amines of formula (I) or (II): 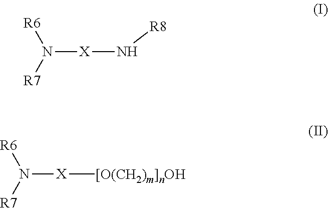
wherein:
R6 and R7 are identical or different and represent, independently from one another, an alkyl group having from 1 to 22 carbon atoms;
X is an alkylene group having from 1 to 20 carbon atoms;
m is an integer between 1 and 5;
n is an integer between 0 and 20; and
R8 is a hydrogen atom or a C1 to C22 alkyl group;
and preferably from the amines of formula (I).

9. The use according to claim 6, characterised in that the fuel composition comprises the first additive(s) with a content ranging from 5 to 1000 ppm, in relation to the total weight of the composition.

10. The use according to claim 1, characterised in that the fuel composition further comprises at least one second additive consisting of an antioxidant agent selected from the compounds comprising a phenol group in a content ranging from 2 to 500 ppm, in relation to the total weight of the composition.

11. The use according to claim 1, characterised in that the fuel composition further comprises:
one or more amino antioxidant agents selected from aliphatic, cycloaliphatic and aromatic amines, in a content ranging from 0.5 to 25 ppm, in relation to the total weight of the composition; and/or
one or more metal passivator agents selected from amines substituted by triazole groups, alone or in a mixture, in a content ranging from 0.5 to 25 ppm, in relation to the total weight of the composition; and/or
one or more chelating agents, present in a content ranging from 0.2 to 50 ppm, in relation to the total weight of the composition.

12. The use according to claim 1, for reducing the deposits present in the internal parts of an engine selected from the following: the combustion chamber and the fuel injection system, and preferably the fuel injection system.

13. The use according to claim 1, characterised in that the compression ignition engine is an engine equipping a vehicle or stationary machinery.

14. The use according to claim 13, characterised in that the engine is a motor vehicle diesel engine.

15. A method for cleaning the deposits present in the internal parts of a compression ignition engine, consisting of performing the combustion in said engine of a fuel composition as defined in claim 1.
